(19) United States
(12) Patent Application Publication
(10) Pub. No.: US 2006/0175228 A1
(43) Pub. Date: Aug. 10, 2006

(54) Kitchen utensil with interchangeable heads

(76) Inventors: David Howel, Margate, FL (US); Tessa Baker, Margate, FL (US); Michael Anthony, Coral Springs, FL (US)

Correspondence Address: Mark D. Bowen;Stearns Weaver Miller, et al., Suite 1900, 200 East Broward Boulevard, Fort Lauderdale, FL, 33301, US

(21) Appl. No.: 11/054,132

(22) Filed: Feb. 8, 2005

(51) Int. Cl. B65D 79/00; A47J 43/28

(52) U.S. Cl. 206/751; 30/147

(57) ABSTRACT

A kitchen utensil system including a universal handle and modular heads adapted for quick and easy interchangeable attachment to the handle. The interchangeable heads may include a fork, spoon, spatula, straining ladle, mixer, or any other suitable head. A storage basket is provided for compact and convenient storage of the handle and interchangeable heads, and maintains all of the components in a single compact configuration when placed in a dishwashing machine. The storage basket further functions to keep the heads organized and accessible during use, and includes a cover that doubles to contain drippings.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to kitchen utensils, and more particularly to kitchen utensils having modular, interchangeable, detachable heads.

2. Description of Related Art

Cooking utensils having detachable and interchangeable heads or implements have been known in the art for several years. In particular, many of these devices include a handle and several heads and/or implements that may be interchangeably attached to and detached from the handle. These devices range in use from kitchen utensils, to utensils for infants. For example, U.S. Pat. No. 5,479,708, issued to Thomas, discloses a utensil holder for infants and toddlers that is made up of a generally triangular handle and a utensil head. The handle includes a gripping area and a hollow socket that receives a selected utensil head. The utensil head, in turn, includes a tapered shank with a protuberance that fits inside the hollow socket. The hollow socket further includes a depression for receiving the protuberance on the tapered shank. The utensil head, and more particularly, the tapered shank, may be forced into the hollow socket of the handle such that the protuberance fits into the depression in the socket, thus locking the utensil head into place. The utensil head may be forcibly removed from the handle by the user and thus does not provide for easy or sanitary interchangeability.

While this and other prior art devices have presumably worked suitably for their specific applications, none are suited for the present contemplated application. Accordingly, there remains a need for an integrated kitchen utensil system having modular interchangeable, and detachable heads, wherein detachment and changing of the heads is easily accomplished while avoiding potential contamination by the user's hands. There further exists a need for such a utensil that is dishwasher safe and adapted for convenient storage and cleaning in a dishwasher.

### BRIEF SUMMARY OF THE INVENTION

The present invention overcomes the limitations in the art by providing a kitchen utensil system including a universal handle and modular heads adapted for quick and easy interchangeable attachment to the handle. The interchangeable heads may include a fork, spoon, spatula, straining ladle, mixer, or any other suitable head. A storage basket is provided for compact and convenient storage of the handle and interchangeable heads, and maintains all of the components in a single compact configuration when placed in a dishwashing machine. The storage basket further functions to keep the heads organized during use, and includes a cover that doubles to contain drippings.

Accordingly, it is an object of the present invention to provide improvements in the field of kitchen utensils.

Still another object of the present invention is to provide a kitchen utensil system having a universal handle and interchangeable heads.

Yet another object of the present invention is to provide an kitchen utensil system having a universal handle and interchangeable heads that is further provided with a basket adapted to maintain the head in an organized configuration during storage and use.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a perspective view of a kitchen utensil system according to the present invention stored in a conventional utensil tray;

FIG. 2 is a perspective view of a kitchen utensil system according to the present invention in a compact storage configuration;

FIG. 3 is a perspective view of the universal handle with a mixing head attached thereto;

FIG. 4 is a perspective view of the universal handle with a fork head attached thereto;

FIG. 5 is a perspective view of the universal handle with a spoon head attached thereto;

FIG. 6 is a perspective view of the universal handle with a spatula head attached thereto;

FIG. 7 is a perspective view thereof with the spatula head detached;

FIG. 8 is a perspective view of the universal handle;

FIG. 9 is a detailed view of the head mounting end portion thereof;

FIG. 10 is a perspective view of the handle;

FIG. 11 is a half sectional view of the handle;

FIG. 12 shows an internal spring biased locking mechanism for the handle;

FIG. 13 shows the handle end grip;

FIG. 14 shows the handle body;

FIG. 15 shows the handle finger grip;

FIG. 16 is a perspective view of an attachable fork head;

FIG. 17 is a perspective view of an attachable spatula head;

FIG. 18 is a perspective view of an attachable spoon head;

FIGS. 19 and 20 are perspective views of an attachable strainer ladle head;

FIG. 21 is a perspective view of a storage basket for use with the present invention;

FIG. 22 shows the basket and utensil components in the storage configuration; and

FIGS. 23-25 show the basket and utensil components in the countertop use configurations.

### DETAILED DESCRIPTION OF THE INVENTION

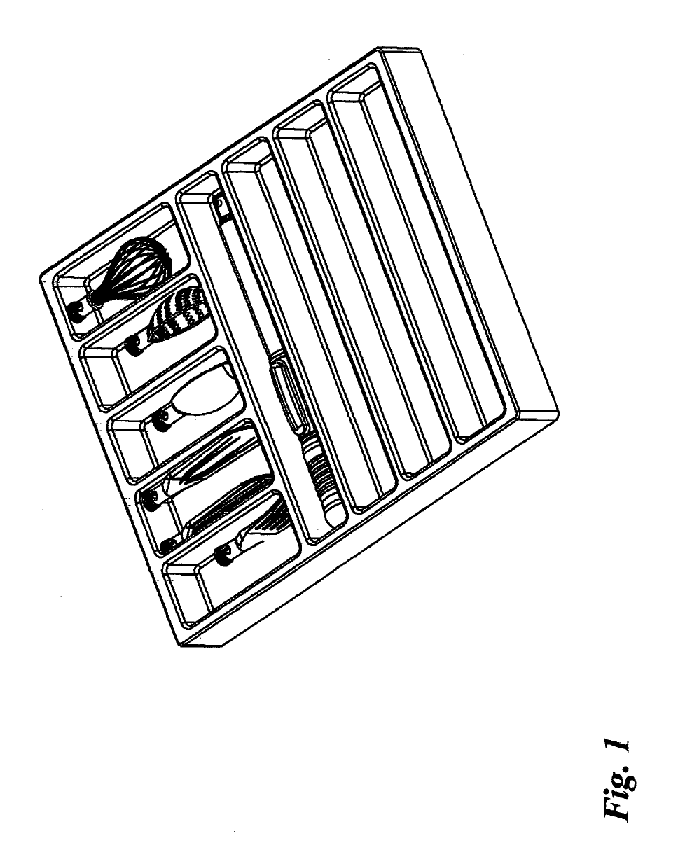

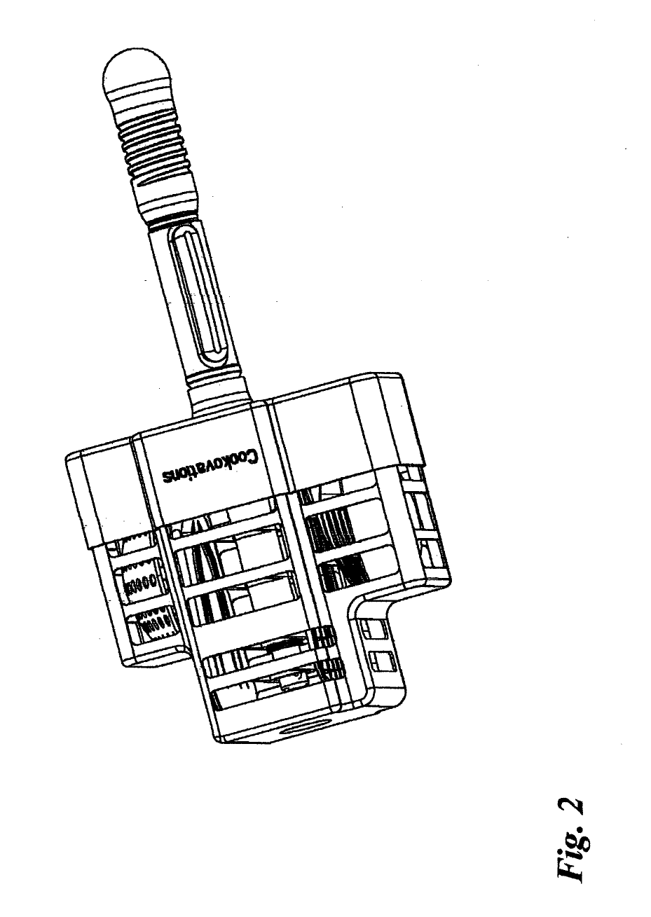

The present invention overcomes the limitations and disadvantages in the art by providing a kitchen utensil system, generally referenced as 10, including a universal handle and modular heads adapted for quick and easy interchangeable attachment to the handle. The present invention thus provides a single universal handle that may be used with a variety of heads while cooking, and further provides a storage basket that allows for compact storage. In accordance with the present invention, a universal handle, generally referenced as 20, is provided with a variety of interchangeable heads, generally referenced as 40, and a storage basket, generally referenced as 60. FIG. 1 depicts the handle 20 and a variety of interchangeable heads 40 disposed in a conventional kitchen drawer storage tray. FIG. 2 depicts the handle, interchangeable heads 40, and storage basket in a compact configuration for storage and/or placement for cleaning in a dishwasher.

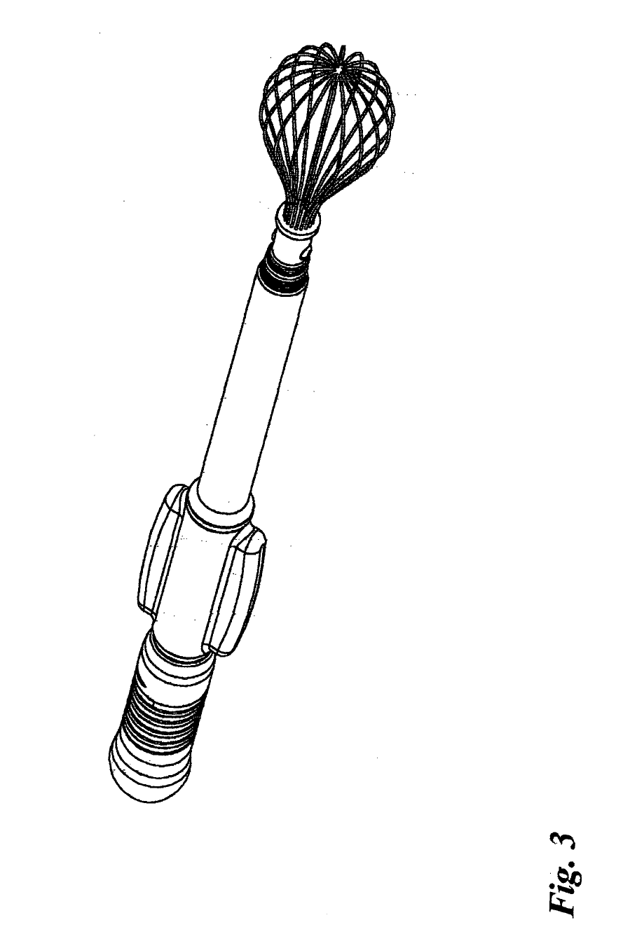

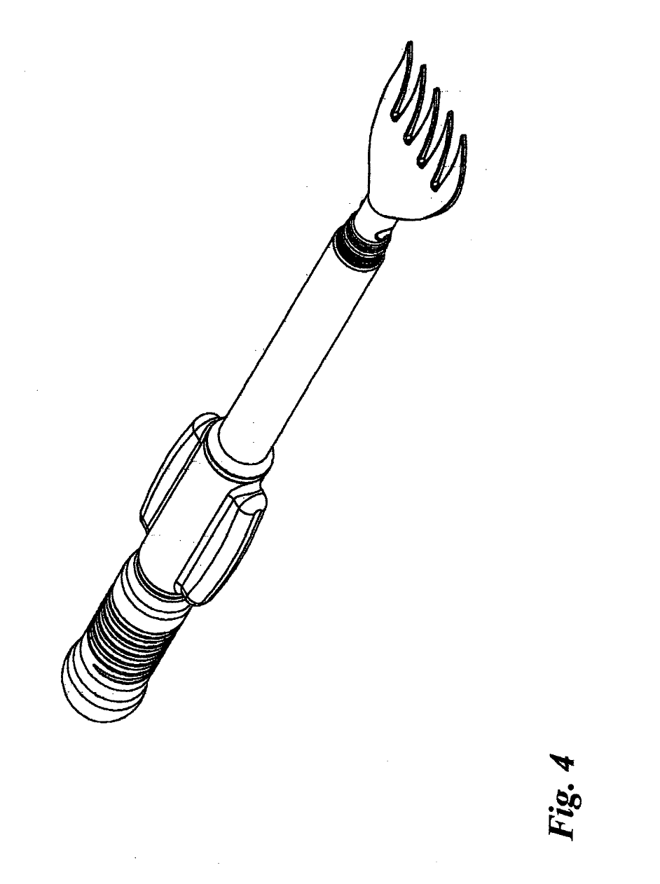

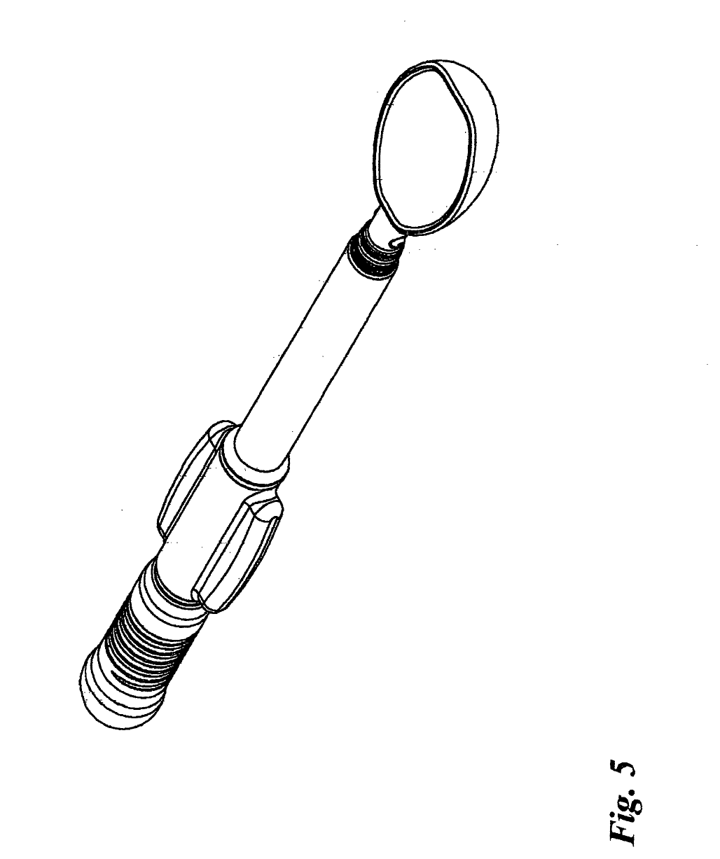

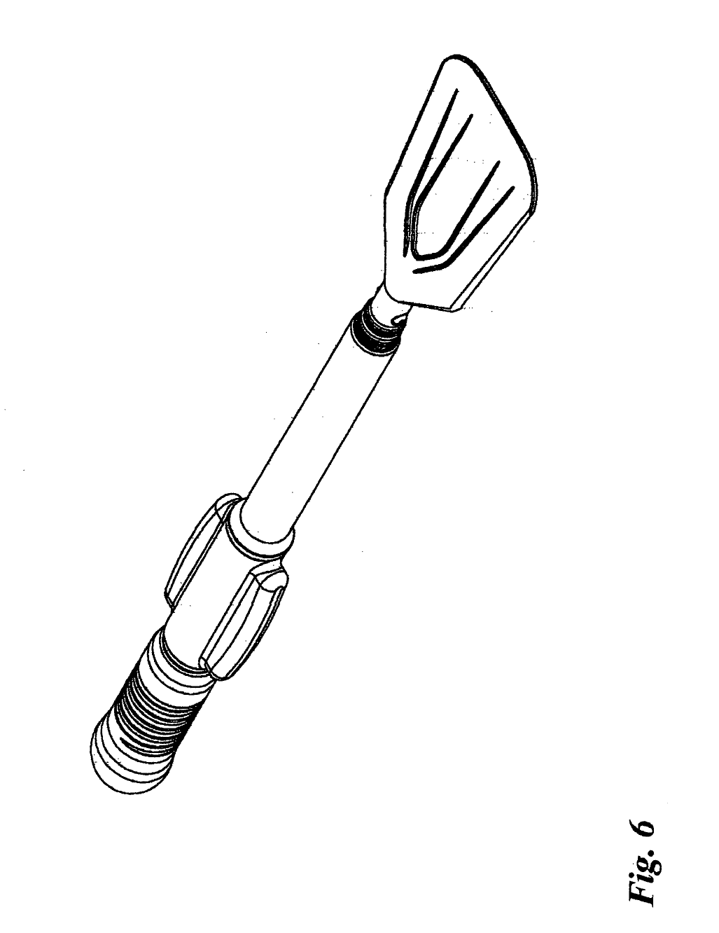

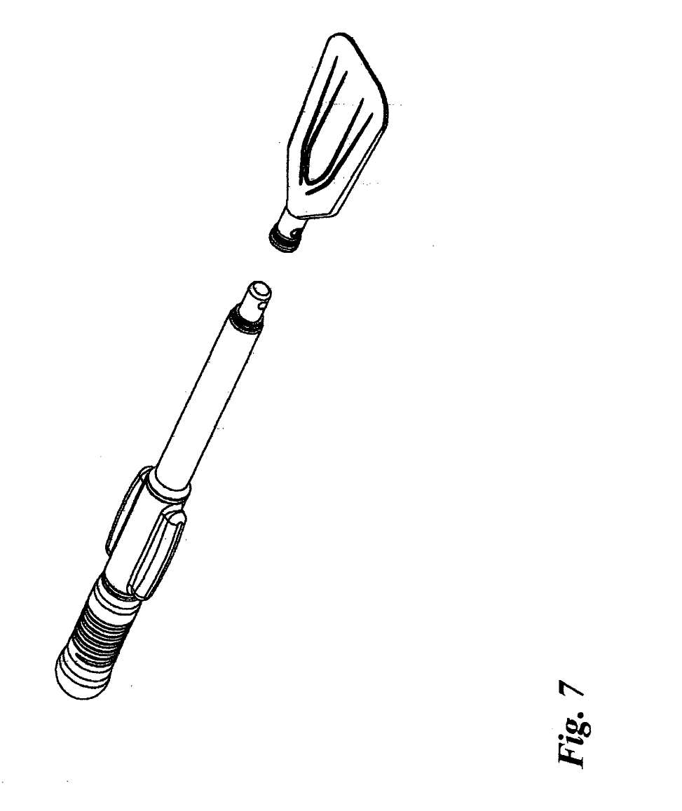

FIGS. 3-7 depict handle 20 in relation with a variety of interchangeable heads. FIG. 3 depicts handle 20 having a mixing head 42 attached thereto. FIG. 4 depicts handle 20 with a fork head 44 attached thereto. FIG. 5 depicts handle 20 with a spoon head 46 attached thereto. FIGS. 6 and 7 depict handle 20 with a spatula head 48 in attached and detached configurations respectively.

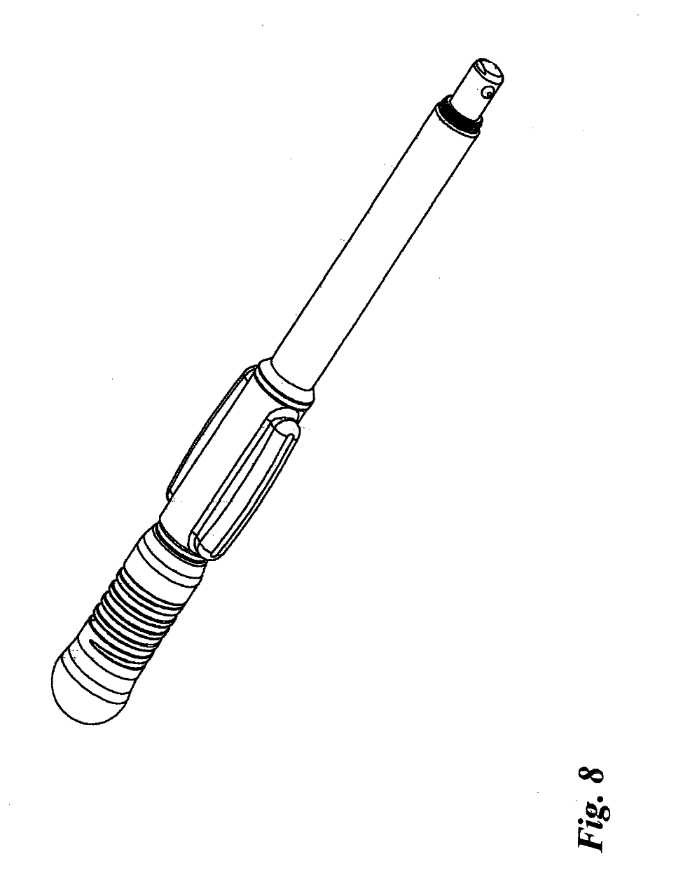

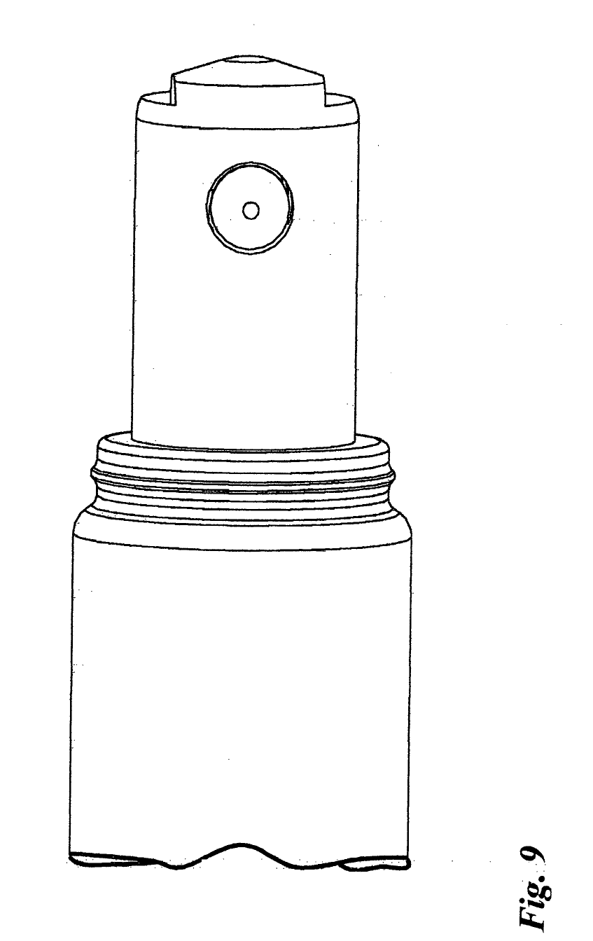

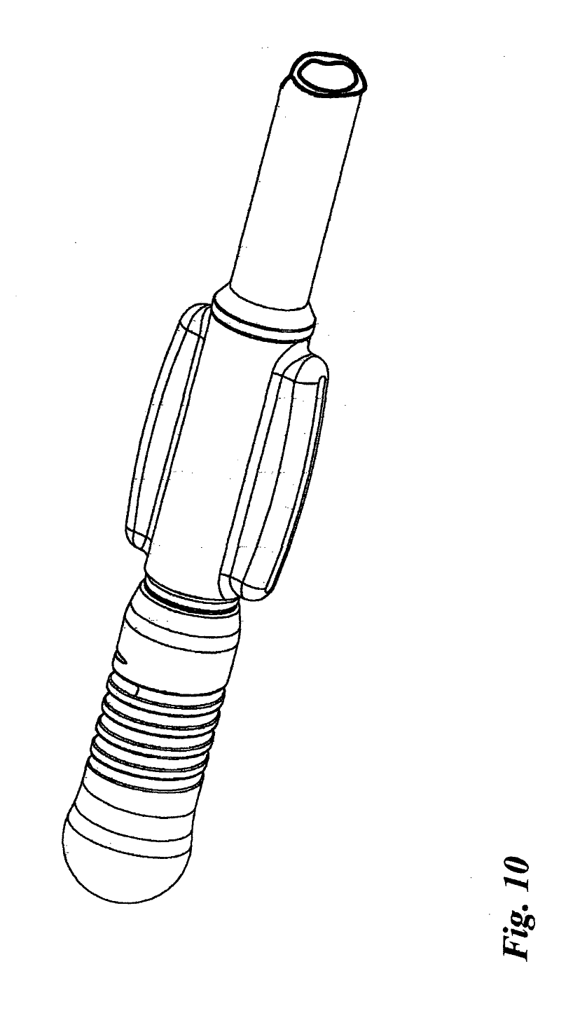

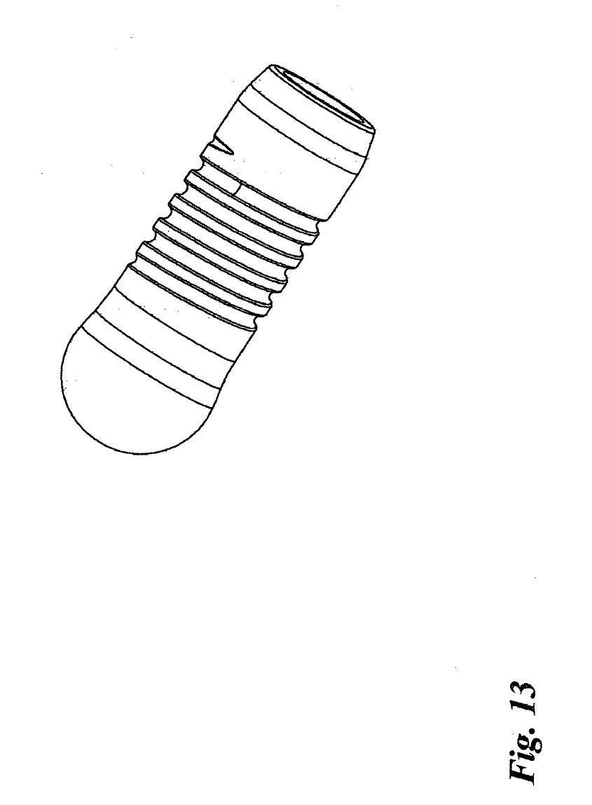

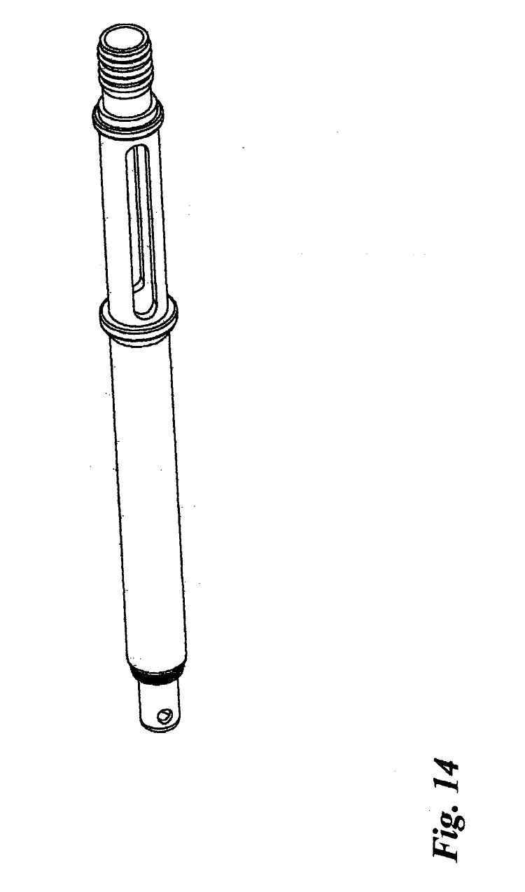

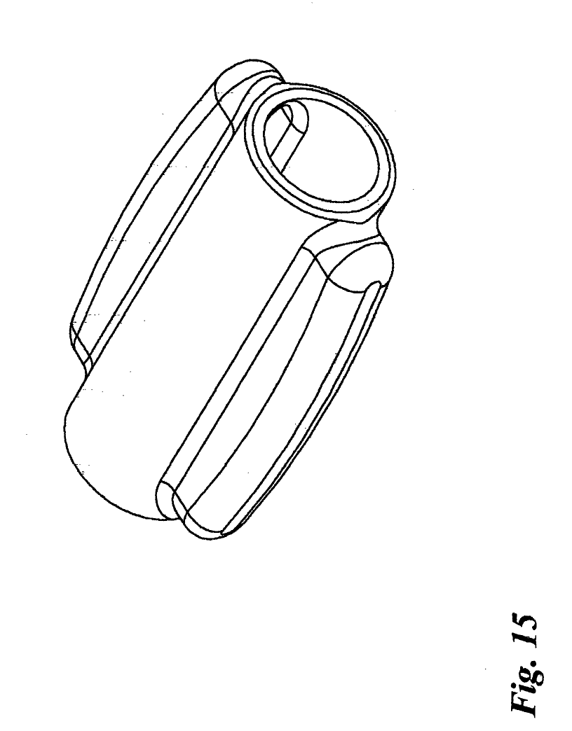

As best depicted in FIGS. 8-15, handle 20 is preferably an elongate apparatus that includes a first end having a grip 22, a second end having an attachment post or shank 24, and an intermediate portion defining laterally projecting finger grip sleeve 26. Grip 22 is preferably attached to handle 20 by threaded engagement and provides an ergonomically shaped grip structure for allowing the user to easily maintain a firm grip on handle 20. Grip 22 may include a rounded end 23 for comfort and raised ridges 25 to provide a non-slip grip. Grip 22 is preferably fabricated from a rubberized or rubber-like material. Finger grip sleeve 26 may be fabricated of a resilient rubber so as to allow for manual inward deformation as further discussed herein below. As noted above, handle 20 further includes a second end having a projecting, generally cylindrical attachment post 24. Attachment post 24 has a cylindrical sidewall having a pair of opposing apertures each of which receives semi-spherical cantilevered snap fit members 28 therein. Snap fit 28 members are movable in a radially inward direction and biased radially outward from attachment post 24 to facilitate a locking snap fit with an attached head. As best depicted in FIG. 9, attachment post 24 further defines a beveled end 27 to facilitate inserted engagement with the heads and planar sections 29 to prevent unwanted rotation of attached heads.

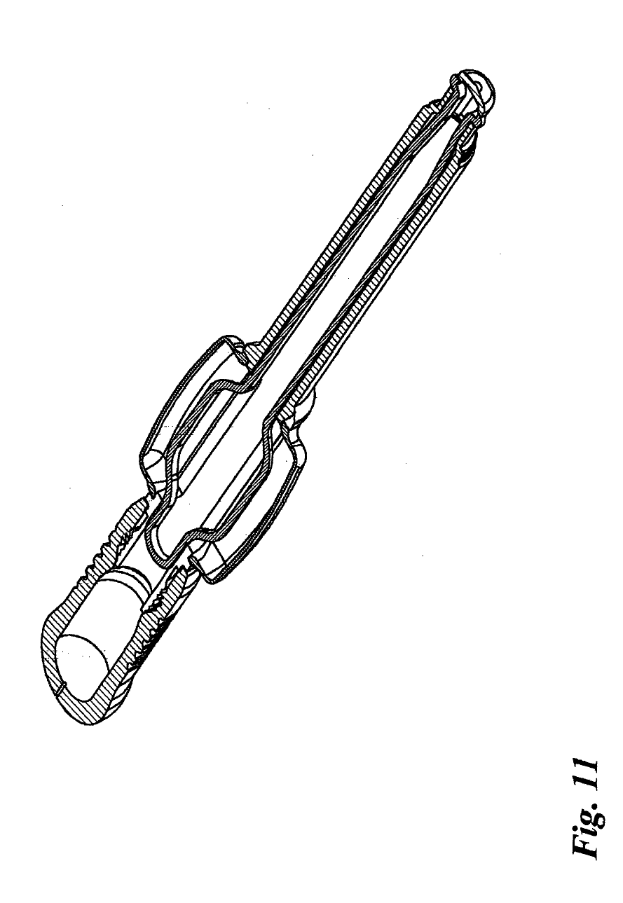

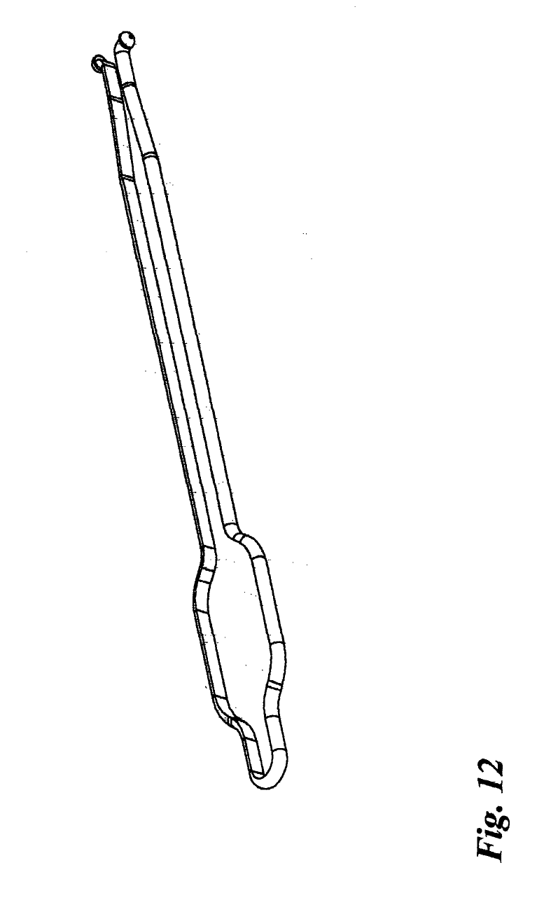

FIG. 11 shows a sectional view of handle 20, and best depicts an internal biasing member, referenced as 30 having an end portion that terminates in snap fit members 28. Biasing member 30 is disposed within the generally hollow handle 20 and includes laterally projecting portions 32 aligned with and received in finger grip sleeve 26. A significant aspect of the present invention relates to the cooperation between finger grip sleeve 26 and biasing member 30 and snap fit members 28. More particularly, the present invention contemplates fabricating finger grip sleeve 26 from a resilient rubber-type material so as to allow the user to manually deform the structures inward so as to engage and likewise deform laterally projecting portions 32 of biasing member 30 inward thereby allowing snap fit members 28 to retract within attachment post 24 to release a previously attached head 40 and/or to allow for attachment of one of said heads 40. FIG. 12 provides a detailed view of biasing member 30. In a preferred embodiment biasing member 30 may be fabricated from metal, plastic, or any other suitable material having spring-like characteristics. Accordingly, manual deformation of finger grip sleeve 26 allows for attachment and/or removal of head without requiring the user to actually touch the heads with his hands.

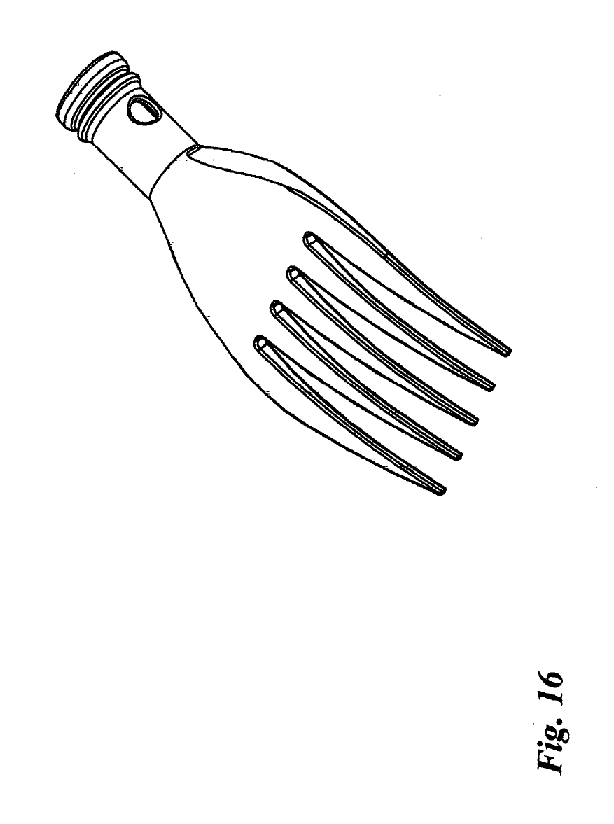

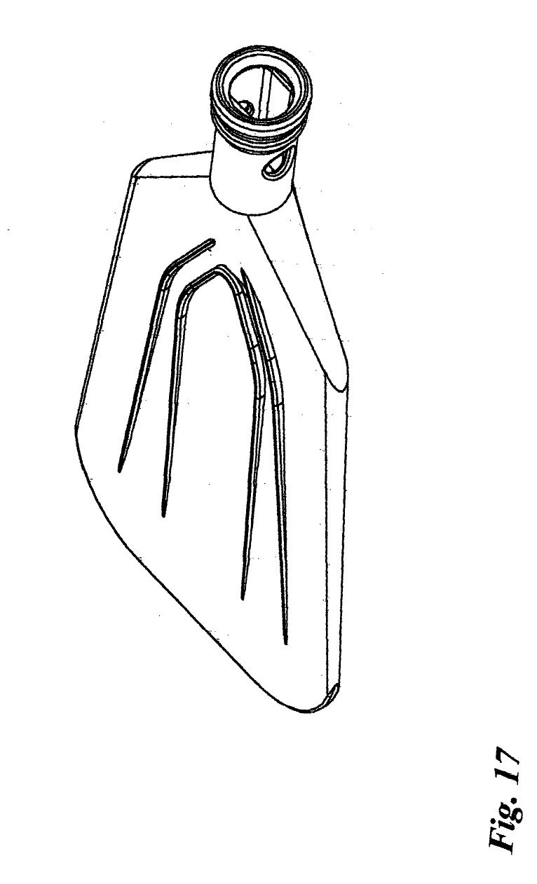

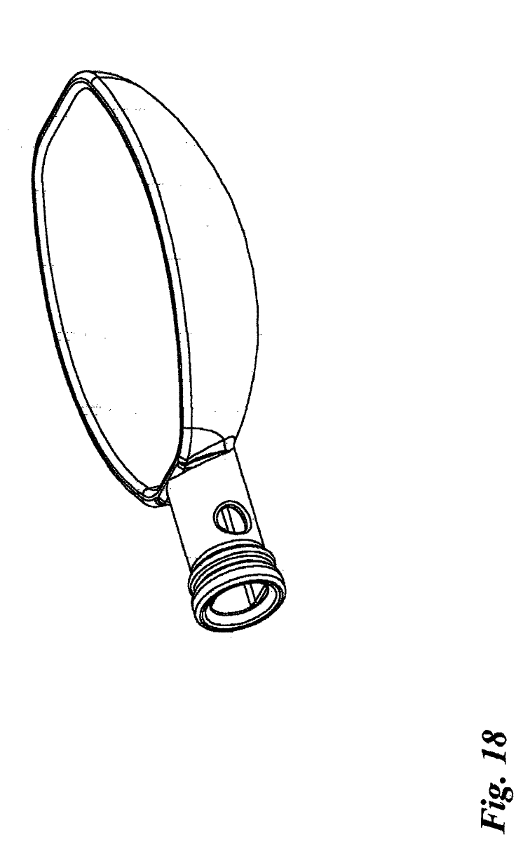

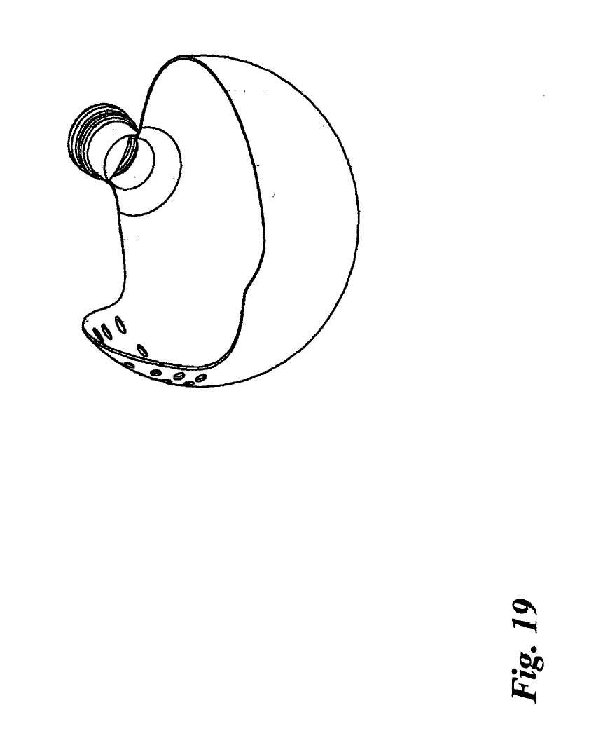

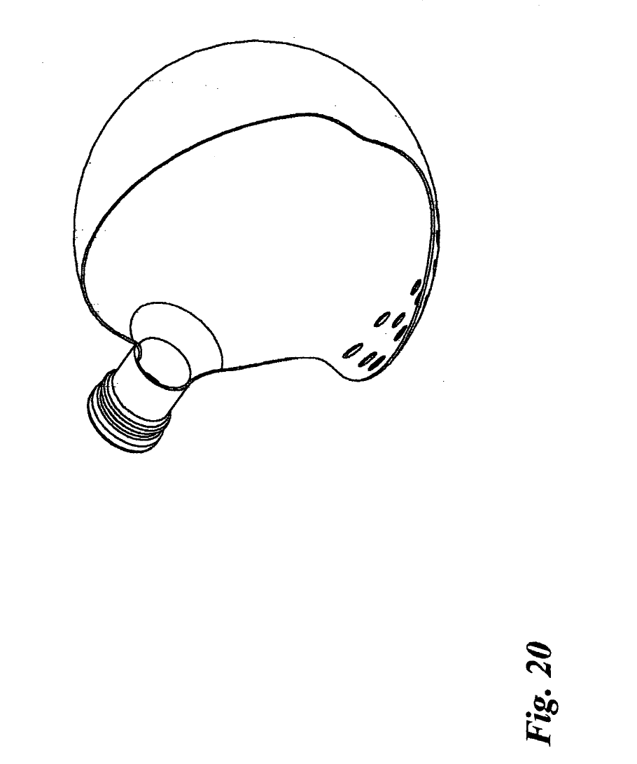

FIGS. 16-20 illustrate a variety of heads for use with the present invention. Each attachable head includes a generally hollow cylindrical sleeve sized for mating engagement with attachment post 24 on handle 20. More particularly, FIG. 16 shows a perspective view of a fork head 44, and particularly reveals a generally hollow cylindrical attachment sleeve 45 adapted for snap fit mating engagement with handle attachment post 24 disposed at the base thereof. FIG. 17 depicts a perspective view of a spatula head 48 having a generally hollow cylindrical attachment sleeve adapted for attachment to post 24 at the base thereof. FIG. 18 depicts a perspective view of a spoon attachment head 46 having an attachment sleeve 47 adapted for snap fit mating engagement with handle attachment post 24. FIG. 19 depicts a perspective view of a combination ladle and strainer attachment head 50 having an attachment sleeve 52 adapted for snap fit mating engagement with handle attachment post 24. The combination ladle and strainer attachment head 50 includes a main ladle body having a strainer portion 54. As should be apparent, the present invention is suitable for use with any suitable modular heads adapted for use with the disclosed handle. While not specifically depicted, the present invention further contemplates an embodiment for attachable knife heads, such as steak knives, bread knives, carving knives, etc.

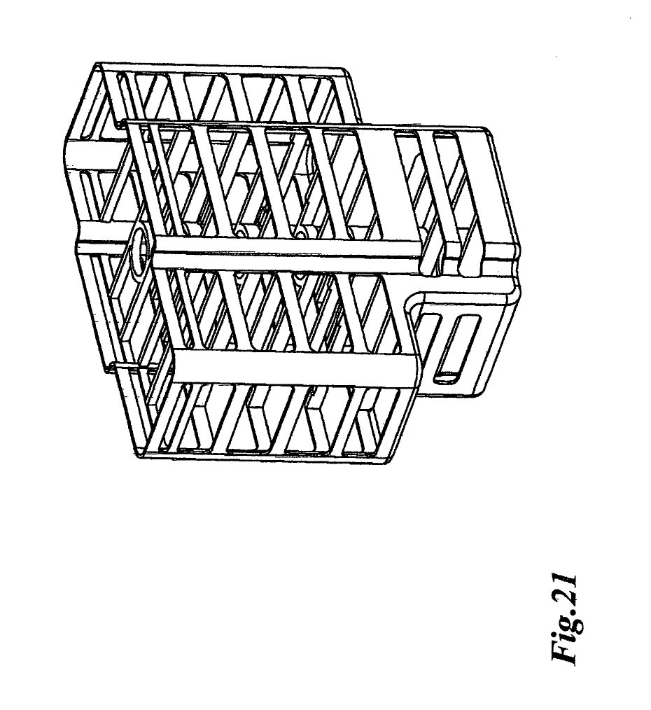

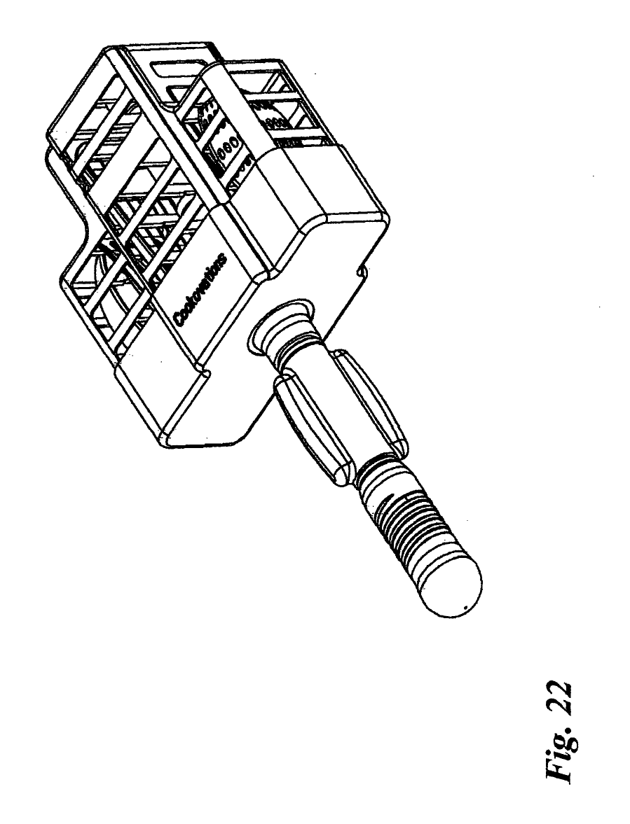

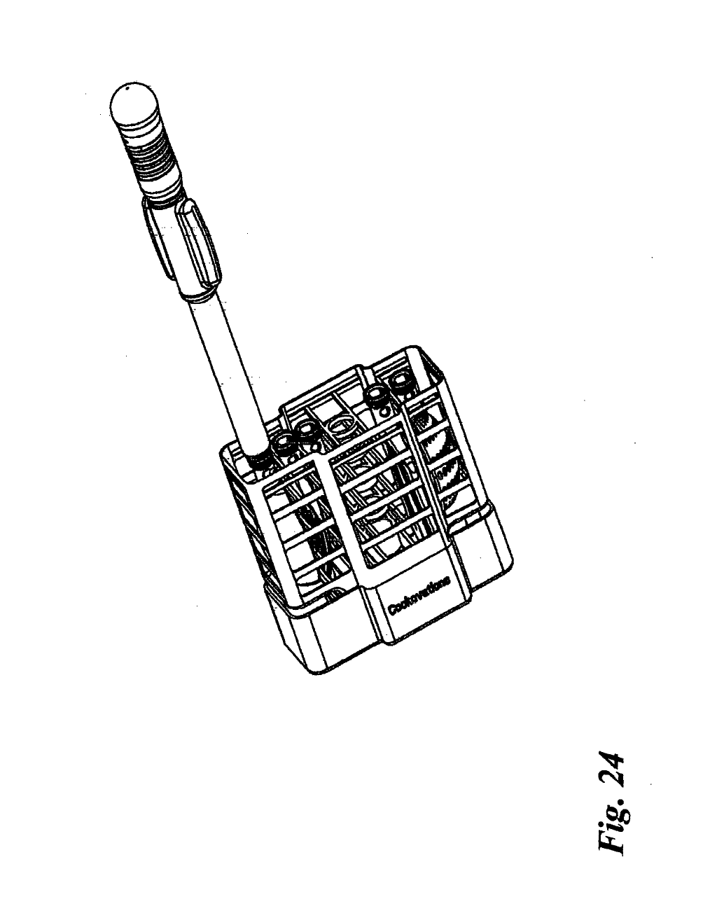

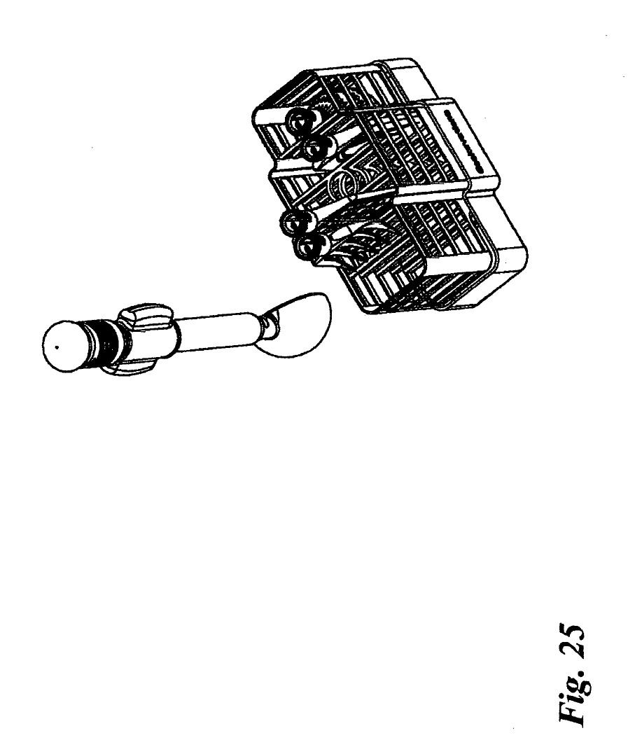

As best depicted in FIGS. 21-25 the present invention further includes a basket assembly, generally referenced as 60, for compact storage of the handle 20 and heads 40. Basket assembly 60 includes a basket 62 and a cover 64 adapted for removable attachment to basket 62. Basket 62 includes a central compartment 66 for receiving a portion of handle 20, and opposing side compartments, each referenced as 68, for receiving heads 40. Central compartment 66 further includes mounting ribs defining circular sleeves 67 for receiving and anchoring a portion of handle 20 in a storage configuration. Cover 64 also defines a circular aperture for inserted reception of handle 20. FIG. 22 shows the present invention in the storage configuration with cover 64 attached to basket 62 and handle 20 inserted therein in the storage configuration. FIG. 22 further shows the attachable heads 40 within the opposing side compartments. In this configuration, basket assembly 60 functions to maintain the handle 20 and heads 40 in a compact storage configuration suitable for placement in a kitchen cabinet while also being suitable for placement in a dish washing machine for cleaning.

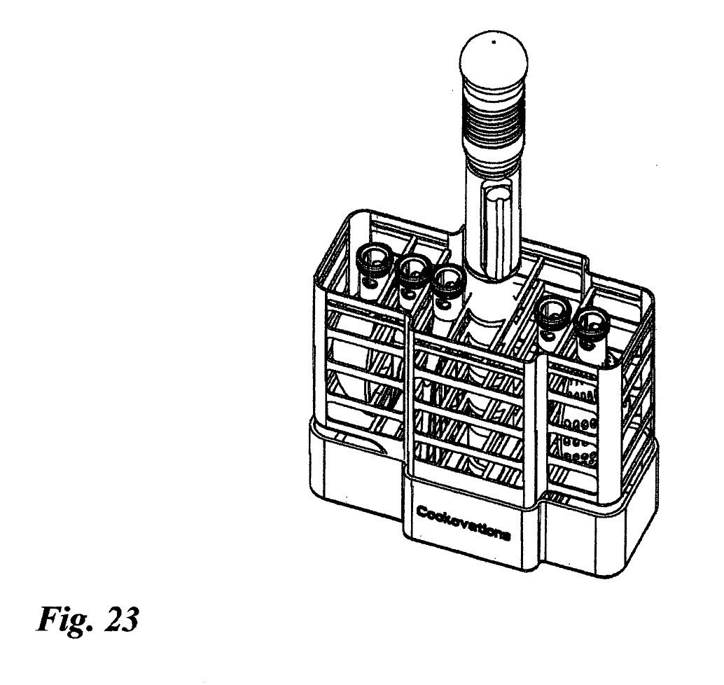

A significant aspect of the present invention relates to use of cover 64 as a base when in use as shown in FIGS. 23-25. More particularly, cover 64 may be removed and attached to the opposite end (i.e. bottom) of basket 62 thereby enabling the basket to be free standing, while providing convenient access to handle 20 and particularly attachable heads 40. In this configuration heads 40 are disposed in a generally vertical orientation with the attachment sleeves on top such that the user may remove and replace heads using handle 20. A further advantage of this configuration is that cover 64, when configured as a base, functions to catch and contain drippings, such as liquids, grease, etc.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A modular kitchen utensil system comprising:
a universal handle having a grip end and an attachment end;
said attachment end defining a shank, said shank including radially projecting snap fit members biased radially outward;
means for manually radially retracting said snap fit members; and
a plurality of attachable heads, each of said attachable heads having an end portion defining a sleeve sized for mating snap fit engagement with said shank.

2. A modular kitchen utensil system according to claim 1, further including a basket having an open top, a first chamber for receiving said universal handle, and at least one additional chamber for receiving said plurality of attachable heads.

3. A modular kitchen utensil system according to claim 2, wherein said basket includes a cover, said cover adapted for attachment to said basket in a first configuration wherein said cover is in covering relation with said basket top and a second configuration wherein said cover is in covering relation with the basket bottom whereby said cover functions to catch drippings.

4. A modular kitchen utensil system according to claim 1, wherein said plurality of attachable heads includes a fork, a spoon, a spatula, and a mixer.

5. A modular kitchen utensil system comprising:
a handle having a grip end and an attachment end defining a shank, said shank having a generally cylindrical side wall defining a pair of opposing apertures;
said handle defining an internal chamber;
a pair of elongate members disposed within said chamber and spring biased radially outward, said elongate members each having a first end disposed in proximity to said grip and a second end terminating in a snap fit surface, said snap fit surface received within one of said shank apertures and projecting from said shank side wall;
said grip end including a flexible outer wall, whereby manual radial inward deformation of said flexible outer wall causes said elongate members to retract said snap fit members; and
a plurality of attachable heads, each of said attachable heads having an end portion defining a sleeve sized for mating snap fit engagement with said shank, said sleeve defining a pair of opposing apertures for receiving at least a portion of said one of said snap fit members in an attached configuration.

6. A modular kitchen utensil system according to claim 5, further including a basket having an open top, a first chamber for receiving said universal handle, and at least one additional chamber for receiving said plurality of attachable heads.

7. A modular kitchen utensil system according to claim 6, wherein said basket includes a cover, said cover adapted for attachment to said basket in a first configuration wherein said cover is in covering relation with said basket top and a second configuration wherein said cover is in covering relation with the basket bottom whereby said cover functions to catch drippings.

8. A modular kitchen utensil system according to claim 5, wherein said plurality of attachable heads includes a fork, a spoon, a spatula, and a mixer.
